(19) United States
(12) Patent Application Publication
(10) Pub. No.: US 2024/0288829 A1
(43) Pub. Date: Aug. 29, 2024

(54) TIMEPIECE

(71) Applicant: REALIZATION DESAL AG, Oberwil bei Zug (CH)

(72) Inventor: Michael BONKE, Oberwil bei Zug (CH)

(21) Appl. No.: 18/573,161

(22) PCT Filed: Jun. 1, 2022
(86) PCT No.: PCT/EP2022/064911

§ 371 Date: Jan. 22, 2024

(30) Foreign Application Priority Data
Jun. 25, 2021 (DE) 102021116556.3

(51) Int. Cl. G04C 3/12; G04C 1/06; G04C 10/04

(52) U.S. Cl. CPC G04C 3/12; G04C 1/06; G04C 10/04

(57) ABSTRACT

The present invention relates to a watch comprising a clock generator arrangement, a gear train, a drive device for driving the gear train, and a watch display device, which is connected to the gear train. The clock generator arrangement has a clock generator, an electronic useful signal generating device and an electromechanical device. Here, the clock generator has a predetermined oscillation frequency. The electronic useful signal generating device is set up to generate a useful signal based on the oscillation frequency of the clock generator. The electromechanical device is movable using the useful signal generated by the electronic useful signal generating device, whereby the electromechanical device engages directly or indirectly with the gear train in a clocked manner. The watch display device is movable by the gear train.

### CROSS-REFERENCE TO RELATED APPLICATIONS

This application is a National Stage of International Application No. PCT/EP2022/064911, filed Jun. 1, 2022, which claims priority based on German Patent Application No. 102021116556.3, filed Jun. 25, 2021, the entire disclosures of which are incorporated herein by reference.

### TECHNICAL FIELD

The invention relates to a watch, which has advantages of a self-winding or hand-winding mechanical watch and a quartz watch.

### BACKGROUND

Quartz watches are timed by the frequency of an oscillation quartz. On the other hand, self-winding mechanical watches, also known as automatic watches, and hand-winding mechanical watches are generally controlled by the oscillation of a balance wheel that controls the so-called escapement. Quartz watches are usually much more accurate than automatic watches or hand-winding mechanical watches, because the reference frequency of an oscillation crystal is much more stable and independent than the frequency of a mechanical oscillation device.

In wristwatches in particular, the mechanical oscillation device is slowed down or accelerated by each movement of the wrist. The degree of tension of the drive spring of the clockwork has an influence on the escapement and also on the frequency of the tandem of balance wheel/escapement. The position of the watch (horizontal or vertical) also has an influence on the oscillation behavior of the balance wheel.

Compared with that, the frequency of an oscillation crystal in a wristwatch is very independent. Only the deviation from the standard temperature, for which the oscillation crystal was designed and configured, can influence the frequency of the oscillation crystal.

Furthermore, a quartz watch has the advantage that it has a much longer power reserve, usually via several years.

Nevertheless, automatic watches and mechanical watches with hand-winding are generally much more favored as wristwatches than quartz watches. In particular, automatic watches do not require a battery change and are an expression of the centuries-old art of watchmaking.

### SUMMARY

In the following, a watch is described, which comprises a clock generator arrangement with a clock generator, a gear train, a drive device for driving the gear train and a watch display device, which is connected to the gear train and is movable by the gear train. Here, the clock generator has a predetermined oscillation frequency.

For providing the clock generator with the predetermined oscillation frequency, a desired oscillation frequency, which the clock generator should have, can preferably firstly be selected, and then the clock generator can be formed such, that the desired oscillation frequency is achieved. For this purpose, after the clock generator has been formed, it can be measured for determining the actual frequency of the clock generator. In the case of a deviation of the actual frequency from the desired frequency, the clock generator can be modified correspondingly until the desired frequency is achieved. Here, the desired frequency corresponds to the predetermined oscillation frequency of the clock generator.

However, it is also possible that a clock generator is firstly arbitrarily formed. Subsequently, the formed clock generator can be measured for determining the oscillation frequency of the clock generator. Here, the oscillation frequency determined in this way corresponds to the predetermined oscillation frequency of the clock generator.

It should be noted that the clock generator arrangement, in particular the clock generator, is the frequency-determining element of the watch.

In particular, the drive device is to be understood as a mechanical drive device, that is, without an electric motor drive or other electric drive. The drive device preferably comprises a drive spring as an energy storage. The watch preferably comprises a winding device for self-winding (automatic watch) and/or hand-winding.

The gear train preferably comprises at least an hour wheel and/or a minute wheel and/or a second wheel and/or a third wheel.

Preferably, the clock generator arrangement further has an electronic useful signal generating device and an electromechanical device. The electronic useful signal generating device is set up to generate a useful signal based on the oscillation frequency of the clock generator. The electromechanical device is movable using the useful signal generated by the electronic useful signal generating device, whereby the electromechanical device directly or indirectly engages with the gear train in a clocked manner. In particular, the electromechanical device engages directly or indirectly with the gear train in an inhibiting manner, in order to alternately bring the gear train to a standstill and release it again. The watch is thus timed in its rate not by an oscillating balance wheel, but via a frequency-controlled device (the electromechanical device), wherein the drive energy for the gear train is provided by a mechanical drive device. In other words, the inaccurate mechanical balance wheel is replaced by the previously described clock generator arrangement.

Thus, the advantages of a hand-winding or self-winding mechanical watch and a quartz watch are realized in one watch by controlling an automatic movement or a hand-winding mechanical movement by the electronic frequency of a clock generator. The clock generator can be based on a piezoelectric oscillation crystal. However, it can also be a question of an oscillation system, in which the frequency-determining unit is not a simple oscillation crystal, but another mechanism, such as an optical fiber or an oscillator on any other basis. As no balance wheel is provided in the proposed watch, all mechanical influences that affect the timing of the balance wheel and thus the accuracy of the time flow of the watch are eliminated here. The reference frequency, which is used for timing the watch and corresponds to the oscillation frequency of the clock generator, is not influenced by a movement of the wearer of the watch. Thus, a mechanical watch is enabled in terms of driving the gear train, which is much more precise than a common mechanical watch with a balance wheel.

As the electromechanical device is movable using the useful signal generated by the electronic useful signal generating device, and the useful signal can be generated based on the oscillation frequency of the clock generator, it is to be understood that the electromechanical device is frequency-controllable or rather frequency-controlled.

According to an option, the electromechanical device engages indirectly with the gear train. “Indirectly” according to the present invention means, in particular, that at least one further component is arranged between the electromechanical device and the gear train. That is, in this design of the watch, the electromechanical device is movable using the aforementioned useful signal, whereby the electromechanical device indirectly engages with the gear train for blocking.

Preferably, the watch comprises an escapement for this purpose. Here, the escapement is in engagement with the gear train. The electromechanical device here drives the escapement. This means that in this design of the watch, the electromechanical device is movable using the useful signal generated by the electronic useful signal generating device, whereby the electromechanical device engages with the gear train via the escapement. In other words, the escapement here corresponds to the above-mentioned at least one further component, which is arranged between the electromechanical device and the gear train.

Preferably, the escapement comprises an escapement wheel and an inhibition piece. The inhibition piece serves to inhibit the escapement wheel. Here, the electromechanical device is arranged to drive the inhibition piece, wherein the escapement wheel is in engagement with the gear train.

In particular, the escapement is formed as an anchor escapement, wherein the inhibition piece is formed as an anchor. In this case, the escapement wheel can also be referred to as an anchor wheel.

According to an alternative advantageous design of the invention, the electromechanical device can engage directly/immediately with the gear train. “Directly” or “immediately” according to the present invention means, in particular, that no other component is arranged between the electromechanical device and the gear train. That is, in this design of the watch, the electromechanical device is movable using the aforementioned useful signal, whereby the electromechanical device engages directly with the gear train in a clocked manner.

Irrespective of whether the electromechanical device engages directly or indirectly with the gear train, the electromechanical device can be formed as an actuator according to a advantageous embodiment of the invention. Within the framework of the present invention, an actuator is in particular referred to as a driving device or structural unit that converts an electrical signal into a mechanical movement.

Particularly preferably, the actuator can comprise a magnetic anchor and a magnetic coil. In this case, the magnetic coil is set up to move the magnetic anchor using the useful signal.

Alternatively, the electromechanical device can preferably be formed as a stepper motor. In this design of the electromechanical device, it is particularly advantageous, when the electromechanical device engages directly in a clocked manner with the gear train.

Regarding the clock generator, this can be formed as a piezoelectric oscillation crystal according to an advantageous design of the invention.

Preferably, the piezoelectric oscillation crystal can have a length, a width and a height each of at least 1 mm, preferably of at least 1.5 mm, further preferably of at least 3 mm, particularly preferably of at least 5 mm. Thus, the piezoelectric oscillation crystal has a solid mass, which enables it to oscillate stably. In particular, the stability of the oscillation of the piezoelectric oscillation crystal is ensured without it having to be under vacuum. Therefore, a vacuum socket or vacuum bell jar for receiving the piezoelectric oscillation crystal can be dispensed with. Furthermore, the proposed dimensioning of the oscillation crystal has the advantage that the oscillation crystal is subject to no or only negligible ageing. Thus, the piezoelectric oscillation crystal fulfills the technical requirements of a precisely functioning frequency oscillator and can thus serve as a clock generator of the clock generator arrangement of a watch.

Furthermore, the piezoelectric oscillation crystal can be used as a decorative element of the watch due to its highly visible form and mass as well as the elimination of a vacuum socket or vacuum bell jar. For these reasons, different piezoelectric oscillation crystals can be used for the clock generator of the clock generator arrangement. The watch can thus be individualized, giving the watch a high-quality flair. In addition, the piezoelectric oscillation crystal can be selected with regard to its material properties as well as piezoelectric or optical properties for the respective application.

The length, the width and the height of the piezoelectric oscillation crystal extend in a direction of a first axis, a second axis and a third axis of a three-dimensional coordinate system, wherein the first axis, the second axis and the third axis are perpendicular to each other. The coordinate system is preferably arranged at an vertex of the piezoelectric oscillation crystal.

Within the framework of the invention, the length, width and height refer to the actual oscillating part of the piezoelectric oscillation crystal. That is, the length, width and height of the piezoelectric oscillation crystal correspond to the dimensions of the piezoelectric oscillation crystal that are relevant for its oscillation. For example, in the case of a piezoelectric oscillation crystal in the form of a tuning fork, the fork tines are the actually oscillating part of the oscillation crystal. This means in particular that the length, width and height of such a piezoelectric oscillation crystal correspond to the length, width and height of each of the fork tines.

Within the framework of the invention, the length, width or height of a piezoelectric oscillation crystal are understood to be, in particular, the respective dimension of a single edge of the oscillation crystal and not the sum of the dimensions of two edges of the oscillation crystal, which extend in the same direction, when the oscillation crystal is formed in such a way that a free space is formed between the edges. In particular, within the framework the invention, the length, width or height of an oscillation crystal are to be understood as the corresponding actual size of an edge of the oscillation crystal and not the “apparent size” of the oscillation crystal as a whole body, when the oscillation crystal is formed, such that it has a free space between two opposing side faces of the oscillation crystal. For example, in the case of a piezoelectric oscillation crystal in the form of a tuning fork, a width of the piezoelectric oscillation crystal corresponds neither to the sum of the widths of the two fork tines nor to the apparent width of the oscillation crystal measured from a vertex of the one fork tine to the corresponding vertex of the other fork tine, when the width of the free space between the two fork tines is taken into account in the measurement.

Particularly preferably, the piezoelectric oscillation crystal can be a quartz oscillation crystal or a tourmaline oscillation crystal. The quartz oscillation crystal can be formed as a natural or synthetic oscillation crystal. However, it is also possible that a quartz variant, such as e.g. a natural amethyst crystal or citrine crystal, a natural tourmaline oscillation crystal or a natural Swiss rock crystal is used as the clock generator of the clock generator arrangement of the watch.

According to a first particularly advantageous option of the clock generator formed as a piezoelectric oscillation crystal, the clock generator is formed as a tourmaline oscillation crystal having a length, a width and a height each of at least 1 mm, preferably of at least 1.5 mm, further preferably of at least 3 mm, particularly preferably of at least 5 mm.

According to a second particularly preferable option of the clock generator formed as a piezoelectric oscillation crystal, the clock generator is formed as a quartz oscillation crystal, in particular as a synthetic quartz crystal, in the form of a fork oscillator. In particular, the quartz oscillation crystal can be formed/dimensioned in such a way that it has an oscillation frequency of 32768 Hz. This means that a common quartz oscillation crystal of a common quartz watch can be used as the piezoelectric oscillation crystal in the present watch.

According to an alternative advantageous design of the invention, the clock generator can be formed as an oscillation system comprising an optical fiber, a light transmitter for feeding a clocked light signal into the optical fiber, and a light receiver for receiving the light signal and for generating an electrical signal based on the received light signal. The electronic useful signal generating device is set up to generate the useful signal based on a frequency of the electrical signal.

Within the framework of the invention, the light transmitter can in particular also be termed an electro-optical converter. In particular, the light receiver can also be referred to as an opto-electrical converter within the framework of the invention.

It is to be understood that for feeding the clocked light signal into the optical fiber, the light transmitter is preferably set up to convert an electrical input signal into the light signal.

It is further to be understood that the electrical signal is preferably also clocked, as the light signal is clocked.

According to an advantageous design of the invention, the oscillation system can be formed as an oscillation circuit. This means, in particular, that the components of the oscillation system are arranged in a circuit, i.e. in an endless loop.

The clocked light signal can preferably be an analog clocked light signal, in particular a sinusoidal light signal. However, the analog light signal can also have a form other than the sinusoidal form. Correspondingly, the electrical signal generated by the light receiver can preferably be an analog electrical signal, in particular a sinusoidal electrical signal. However, correspondingly to the light signal, the analog electrical signal can have a form other than the sinusoidal form.

However, it is also possible that the clocked light signal is in particular a digital light signal. Correspondingly, the electrical signal generated by the light receiver can in particular be a digital electrical signal.

Preferably, the light transmitter comprises a semiconductor laser or a light emitting diode.

In particular, the light transmitter can be set up to feed the clocked light signal directly or indirectly into the optical fiber.

For providing the clock generator formed as an oscillation system with the predetermined oscillation frequency, a desired frequency for the clocked light signal and accordingly the electrical signal can preferably firstly be selected and then the oscillation system, in particular the optical fiber with regard to its length, can be formed in such a way that the corresponding desired frequency is achieved. For this purpose, after the oscillation system has been formed, this can be measured for determining the actual frequency of the clocked light signal and accordingly of the electrical signal. If the actual frequency deviates from the desired frequency, the oscillation system can be modified correspondingly until the desired frequency is achieved. However, it is also possible that firstly an oscillation system, in particular an optical fiber, is arbitrarily formed with regard to its length. Subsequently, the formed oscillation system can be measured for determining the frequency of the clocked light signal and accordingly of the electrical signal. Taking the determined frequency into account, the useful signal generating device can thus be set up to generate the useful signal based on the determined frequency. For example, in the case of a useful signal generating device comprising a pulse counter, a predetermined count value, with which an electrical signal counted by the pulse counter is compared, can be set based on the determined frequency of the electrical signal.

Preferably, the light receiver can comprise a photodiode. The photodiode is set up to convert the clocked light signal into the electrical signal. In an advantageous manner, the electrical signal is a current signal.

The light transmitter is advantageously set up to send a light pulse through the optical fiber. Due to the length of the optical fiber, the light pulse traveling in a direction from the light transmitter to the light receiver requires a certain time duration until it arrives at the light receiver. The light pulse is converted into a current pulse by the light receiver. The current pulse is then transmitted to the light transmitter. The predetermined oscillation frequency of the oscillation system can be derived from the current pulse. This process is repeated a certain number of times per second. The number of repetitions per second is determined by the predetermined length of the optical fiber. For example, in the case of a predetermined length of the optical fiber of approx. 20 m, this process is repeated 10 million times per second. Thus, an oscillation frequency of 10 MHz is generated for the clock generator formed as the above described oscillation system.

Further preferably, the oscillation system can have an amplifier arranged between the light transmitter and the light receiver and set up to amplify the electrical signal, in particular the current pulse. Here, the frequency of the electrical signal, in particular of the current pulse, can preferably be picked up between the amplifier and the light transmitter. This frequency then corresponds to the predetermined oscillation frequency of the oscillation system (clock generator).

Furthermore, the oscillation system can preferably have a signal conditioning device, which is arranged between the light transmitter and the amplifier and is set up to condition the electrical signal, in particular the current pulse. The electrical signal, in particular the current pulse, is then passed on to the light transmitter. From there, a new light pulse is sent into the optical fiber. Here, the frequency of the electrical signal, in particular of the current pulse, can preferably be picked up between the signal conditioning device and the light transmitter. This frequency then corresponds to the predetermined oscillation frequency of the oscillation system.

For generating the above-mentioned useful signal, the electronic useful signal generating device can advantageously comprise (only) a pulse counter (binary counter). In this case, the pulse counter is set up to count a clock signal of the clock generator. The pulse counter is programmed with the predetermined oscillation frequency of the clock generator.

When the clock generator is a piezoelectric oscillation crystal, for providing the piezoelectric oscillation crystal, firstly, a raw oscillation crystal can be arbitrarily cut and its oscillation frequency measured. The pulse counter is then programmed with exactly this oscillation frequency, i.e., a predetermined count value of the pulse counter is set based on the measured oscillation frequency. However, it is also possible that the raw oscillation crystal is cut to a predetermined oscillation frequency. Also in this case, the pulse counter is programmed based on the predetermined oscillation frequency.

Furthermore, for generating the above-mentioned useful signal, the clock generator arrangement can preferably comprise (only) a frequency divider. The frequency divider is set up to divide or rather halve the predetermined oscillation frequency of the clock generator. In this case, the predetermined oscillation frequency in particular corresponds to a multiple of two, in particular a power of two, such as 524288 Hz or 1048576 Hz. The predetermined oscillation frequency can be preferably broken down to 1 Hz or another frequency, such as e.g. 8 Hz, by means of the frequency divider. The broken-down oscillation frequency corresponds to the useful signal, by means of which the electromechanical device is movable. It should be noted that in the case of a useful signal of, for example, 8 Hz, the jump of the second hand, which then occurs 8 times per second, is no more perceived as a “jump” by the observer.

The term “only” in use with the terms of the pulse counter or the frequency divider means within the framework of the invention in particular that only one of the two types of electronic components, i.e., either only a pulse counter or only a frequency divider, is provided in the useful signal generating device in order to generate the useful signal based on the predetermined oscillation frequency of the clock generator.

However, a combination of a frequency divider with a pulse counter is also possible for generating the useful signal. This means in other words that the clock generator arrangement can comprise both a frequency divider and a pulse counter for generating the useful signal. In this case, the frequency divider is advantageously arranged in terms of signaling before the pulse counter. In an advantageous manner, the predetermined oscillation frequency of the clock generator can be halved, in particular halved a number of times, in a first step for achieving an intermediate frequency by the frequency divider. In a second step, the intermediate frequency can be brought to a desired frequency or rather a useful frequency. The procedure of halving, in particular of halving a number of times, the predetermined oscillation frequency in a first step for achieving an intermediate frequency and counting down the intermediate frequency to a desired frequency in a second step is particularly advantageous in a watch that has a clock generator with a high oscillation frequency, such as e.g. 8.88 MHz or 10 MHz. Thus, current can be saved compared with simply counting down the oscillation frequency.

Further, the electronic useful signal generating device can preferably comprise an output device. In the case of an electronic useful signal generating device comprising only a pulse counter, the output device is advantageously set up to output a useful signal when a count value of the counted clock signal of the clock generator is equal to a predetermined count value. In the case of an electronic useful signal generating device comprising only a frequency divider, the output device is advantageously set up to output a useful signal based on an output signal of the frequency divider. In the case of an electronic useful signal generating device comprising a pulse counter and a frequency divider, the output device is advantageously set up to output a useful signal when a count value of the counted clock signal of the clock generator is equal with a predetermined count value. Here, the predetermined count value is advantageously set based on the intermediate frequency achieved by the frequency divider.

It should be noted that the pulse counter and the output device or the frequency divider and the output device can respectively be formed as a unit.

The useful signal output by the output device is the useful signal, by means of which the electromechanical device is movable.

The electromechanical device is in this case preferably set up to move in such a way that, in the case of exhausted tension of the drive spring, the electromechanical device drives the gear train. Thereby, kinetic energy flows from the electromechanical device into the gear train, and the electromechanical device drives the gear train. This reserve drive using the electromechanical device occurs in a clocked manner correspondingly to the useful signal. Thus, a long power reserve of the watch can thus be enabled.

When the watch is formed as a self-winding watch, a device for decoupling the drive device from the gear train and/or the escapement, in particular the escapement wheel, is advantageously provided in the watch. This can prevent the drive spring from being wound by the electromechanical device, when the electromechanical device drives the gear train.

In a watch, which comprises an escapement, the electromechanical device is advantageously set up to move such, that in the case of exhausted tension of the drive spring, the electromechanical device moves the escapement such, that the escapement drives the gear train. To realize this in a watch with an escapement formed as an anchor escapement, it requires a well-balanced setting angle and design of the two tines of the anchor (inhibition piece) of the escapement and the setting angle and form of the teeth of the escapement wheel.

When the electromechanical device is formed as a stepper motor, the stepper motor is preferably set up to move in such a way that in the case of exhausted tension of the drive spring the stepper motor drives the gear train.

The watch preferably further comprises a power supply device for power supplying the electronic clock generator arrangement with electrical energy.

The power supply device is particularly preferably formed as a rechargeable battery.

The watch preferably comprises an energy-harvesting device, which is set up to charge the rechargeable battery.

The energy-harvesting device can preferably comprise at least one thermogenerator and/or at least one solar cell. The energy-harvesting device is in an advantageous manner placed in the watch. For example, the dial can be developed as a solar cell. It is also possible that a solar cell is arranged under a semi-transparent dial or at the position of a recess in the dial under the dial. The at least one thermogenerator can, for example, be attached to the watch case bottom of a watch formed as a wristwatch, where it produces electricity from a difference between the temperature of the skin of the wearer of the watch and the temperature of the surroundings of the watch (and thus the temperature of the rest of the watch).

In a watch formed as a wristwatch the at least one solar cell and/or the at least one thermogenerator can, however, also be fitted in the wristband of the watch. For example, there exist textiles, which function as thermogenerators. Thus, the wristband can be formed as such a textile wristband in order to supply the power to the rechargeable battery.

The at least one thermogenerator can preferably comprise a Peltier element.

Further, the watch can further preferably have a charge state measuring device that is set up to measure a charge state of the rechargeable battery.

The watch can further preferably comprise a control unit. The watch is in this case preferably set up to interrupt a power supply of the electromechanical device, when—in the case of exhausted tension of the drive spring—the electromechanical device is running as a backup drive and the charge state of the rechargeable battery is less than a predetermined charge state value.

Although the power supply of the electronic clock generator arrangement, in particular in a self-winding watch, by means of the rechargeable battery is technically advantageous, it is also possible that the watch has a battery instead of a rechargeable battery and the energy-harvesting device.

The watch can preferably be formed as a self-winding watch or a hand-winding watch. When the watch is a self-winding watch, the watch advantageously comprises an oscillation weight, by which a drive spring (drive device) is windable.

When the watch is formed as a self-winding watch, the watch is advantageously formed as a wristwatch. In the case of a hand-winding watch, the watch can preferably be formed as a wristwatch, a grandfather clock, a table clock, a wall clock or another type of clock.

Preferably, the clock generator can comprise an oscillation frequency, which comprises a value that has only the number 8 or only the number 8 and the number 0. In particular, the oscillation frequency can be 8888 Hz, 88888 Hz, 888888 Hz, 8888888 Hz, 8 kHz, 88 KHz, 888 KHz or 8888 KHz.

### BRIEF DESCRIPTION OF THE DRAWINGS

Further details, features and advantages of the invention result from the following description and the figures of embodiments, wherein identical and functionally identical components are respectively designated with the same reference sign.

FIG. 1 a schematic simplified top view of a watch according to a first embodiment of the present invention,

FIG. 2 a schematic view of a part of the watch according to the first embodiment of the invention,

FIG. 3 a schematic view of a part of the watch according to the first embodiment of the invention,

FIG. 4 a schematic view of a part of a watch according to a second embodiment of the invention,

FIG. 5 a schematic view of a part of a watch according to a third embodiment of the invention,

FIG. 6 a schematic view of a region of the watch according to the third embodiment of the invention, and

FIG. 7 a schematic view of a region of a watch according to a fourth embodiment of the invention.

### DETAILED DESCRIPTION

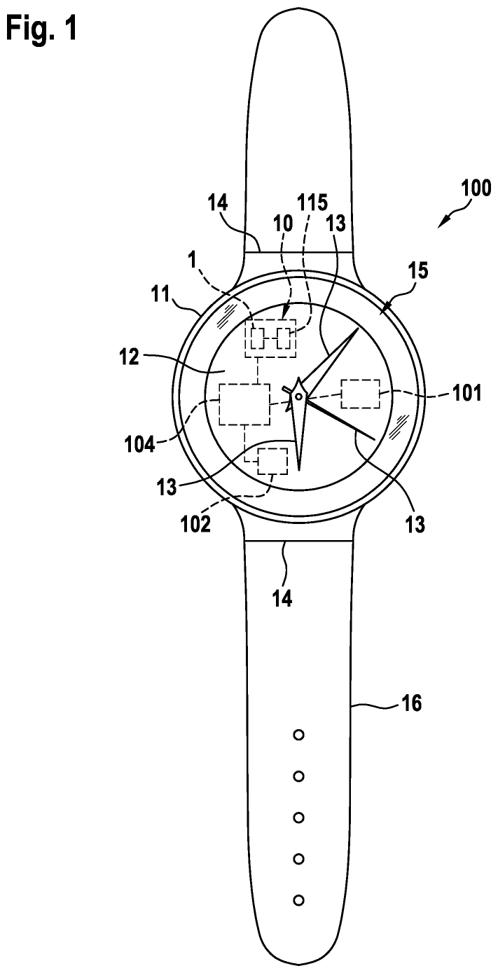

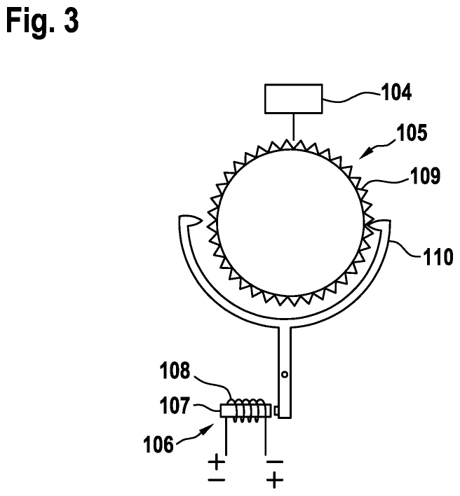

Hereinafter, with reference to FIGS. 1 to 3, a watch 100 according to a first embodiment of the present invention will be described in detail.

As can be seen from FIG. 1, the watch 100 is formed as a wristwatch and thus has two connectors 14 for a wristband 16. However, it is also possible that the watch 100 is a wall clock, a grandfather clock, a table clock or a clock of another type.

The watch 100 comprises a watch case 11 and a watch glass 15 arranged thereon. The watch 100 further comprises a dial 12 and three hands 13 for indicating the hours, minutes and seconds. The hands 13 are parts of a mechanical watch display device 102.

Furthermore, the watch 100 comprises a clock generator arrangement 10, a gear train 104 and a drive device 101 for driving the gear train 104. The gear train 104 is connected to the watch display device 102, so that the hands 13 of the watch display device 102 are moved. In particular, the gear train 104 comprises at least an hour wheel, a minute wheel and a second wheel, which are respectively connected to one of the hands 13.

In a advantageous manner, the drive device 101 comprises a drive spring formed. A winding device 121 is provided in the watch 100 for winding and accordingly tensioning the drive spring. The watch 100 is formed in particular as a self-winding watch. In this case, the winding device is an automatic winding device, which is formed in particular as an oscillation weight, so that the drive spring is automatically wound by the oscillation weight due to the movement of the hand of the wearer of the watch 100. When the drive spring is tensioned, this provides the energy required to drive the gear train 104. However, it is also possible that the watch 100 is formed as a hand-winding watch. In this case, the winding device 121 can be operated manually or rather by hand.

The clock generator arrangement 10, by means which the watch 100 is timed, comprises a clock generator 1, which is formed as a piezoelectric oscillation crystal. The clock generator arrangement 10 ensures that a useful signal is generated based on a predetermined oscillation frequency of the clock generator 1, in this case the piezoelectric oscillation crystal. The useful signal is used to clock the watch 100.

In order to bring the piezoelectric oscillation crystal to oscillate, the clock generator arrangement 10 further comprises an oscillator circuit 115.

In particular, the piezoelectric oscillation crystal can be formed as a quartz oscillation crystal or a tourmaline oscillation crystal.

According to an option, the piezoelectric oscillation crystal can have a length, a width and a height each of at least 1 mm, preferably of at least 1.5 mm. In particular, the piezoelectric oscillation crystal can in this case be formed as a tourmaline oscillation crystal. According to another option, the piezoelectric oscillation crystal can be formed as a quartz oscillation crystal, in particular as a synthetic quartz oscillation crystal, in the shape of a fork oscillator.

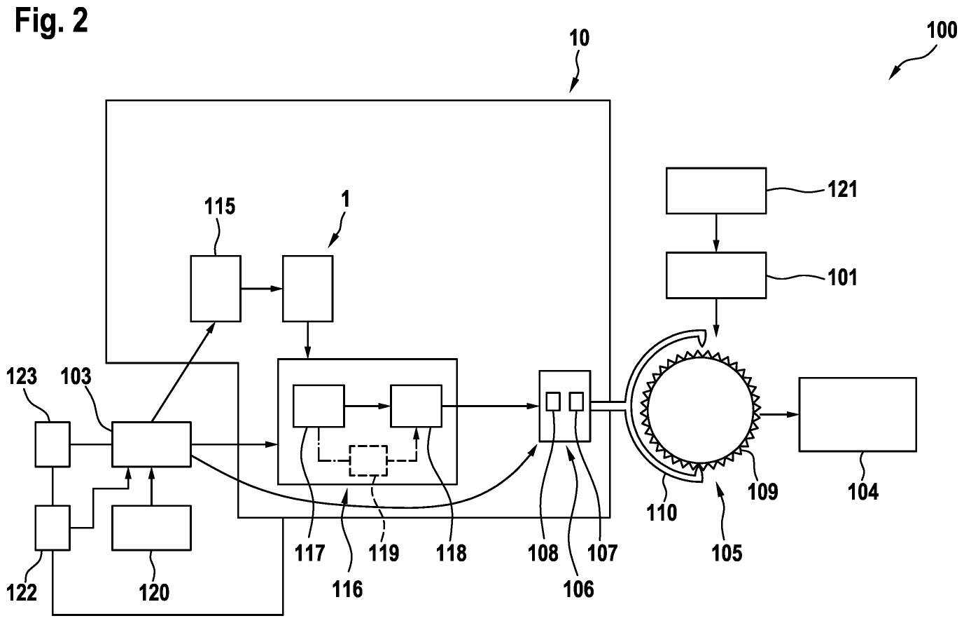

For generating the useful signal, the clock generator arrangement 10 comprises an electronic useful signal generating device 116, as can be seen in FIG. 2. The electronic useful signal generating device 116 comprises a frequency divider 117 and an output device 118. The frequency divider 117 is set up to divide or rather halve the predetermined oscillation frequency of the clock generator 1. In particular, the predetermined oscillation frequency of the clock generator 1 corresponds to a power of two, such as for example 32768 Hz, 524288 Hz or 1048576 Hz. The predetermined oscillation frequency can advantageously be broken down to 1 Hz or another frequency, such as e.g. 8 Hz, using the frequency divider 117. The broken-down oscillation frequency corresponds to the useful signal, which can then be output by the output device 118.

Alternatively, the electronic useful signal generating device 116 can comprise a pulse counter 119 instead of the frequency divider 117. Here, the output device 118 is set up to output a useful signal when a count value of the counted clock signal of the clock generator 1 is equal to a predetermined count value.

However, it is also possible that the electronic useful signal generating device 116 comprises a frequency divider 117 and a pulse counter 119, which are connected to each other. This is indicated in FIG. 2 with a dash-dotted line. In this case, the pulse counter 119 is arranged in terms of signaling after the frequency divider 117. This means that an output signal of the frequency divider 117 serves as the input signal of the pulse counter 119. In a first step, the predetermined oscillation frequency of the clock generator 1 can be halved, in particular halved several times, by the frequency divider 117 for reaching an intermediate frequency. In a second step, the intermediate frequency can be brought to a desired frequency or rather a useful frequency of, for example, 1 Hz or 8 Hz. The output device 118 is then set up to output a useful signal, when a count value of the counted clock signal of the clock generator 1 is equal to a predetermined count value. Here, the predetermined count value is set based on the intermediate frequency achieved by the frequency divider 117.

Furthermore, the clock generator arrangement 10 has an electromechanical device 106. In particular, the electromechanical device 106 is formed as an actuator, which comprises a magnetic core (magnetic anchor) 107 and a magnetic coil 108. Here, the magnetic coil 108 interacts with the magnetic core 107. In particular, the magnetic coil 108 is set up to move the magnetic core 107, when it is supplied with current.

The electromechanical device 106 is movable using the useful signal generated by the electronic useful signal generating device 116 or rather the useful signal output by the output device 118. As a result, the electromechanical device 106, in particular the magnetic core 107, engages with the gear train 104 in a clocked manner.

As can also be seen from FIG. 2, the watch 100 also has an escapement 105, which is arranged between the clock generator arrangement 10, in particular the electromechanical device 106, and the gear train 104. Thus, the electromechanical device 106, in particular the magnetic core 107, indirectly engages with the gear train 104 via the escapement 105. The escapement 105 is drivable by means of the electromechanical device 106.

In particular, the electromechanical device 106 indirectly engages with the gear train 104 in an inhibiting manner, in order to alternately bring the gear train 104 to a standstill and to release it again.

It can be derived from FIG. 2 that the escapement 105 comprises an escapement wheel 109 and an inhibition piece 110 and is formed in particular as an anchor escapement. The escapement wheel 109 is in engagement with the gear train 104, wherein the magnetic core 107 can be brought due to its movement into engagement with the inhibition piece 110. In particular, the inhibition piece 110 is by means of using the magnetic core 107.

In particular, the magnetic coil 108 builds up and removes a magnetic field in the rhythm of the useful signal, whereby the magnetic core 107 is also moved back and forth in the rhythm of the useful signal. The moving magnetic core 107 then engages with the inhibition piece 110 and replaces thereby a conventional balance wheel of a mechanical watch.

To provide power supply to the oscillator circuit 115, the electronic useful signal generating device 116 and the electromechanical device 106, the watch 100 is provided with a power supply device 103, which is formed as a rechargeable battery. The battery can be charged by an energy-harvesting device 120.

The energy-harvesting device 120 can preferably comprise at least one thermogenerator and/or at least one solar cell. In particular, the thermogenerator can comprise a Peltier element.

For example, the dial 12 can be formed as a solar cell. It is also possible that a solar cell is arranged under the dial 12. In this case, the dial 12 must either be formed semi-transparent or comprise a recess at the position of the arrangement of the solar cell. When the watch 100 is provided with a thermogenerator, this can preferably be mounted on the watch case bottom of the watch 100. Thus, this can produce electricity from a difference between the skin temperature of the wearer of the watch 100 and the temperature of the surroundings of the watch (and thus the temperature of the rest of the watch). It is also possible that the at least one solar cell and/or the at least one thermogenerator is/are built into the wristband 16 of the watch 100.

During normal operation of the watch 100, in which the drive spring provides the required energy for driving the gear train 104, the piezoelectric oscillation crystal is firstly made to oscillate with its predetermined oscillation frequency by means of the oscillator circuit 115.

Based on this oscillation frequency, the useful signal generating device 116 generates a useful signal with a useful frequency by means of the frequency divider 117, the pulse counter 119 or a combination of both, depending on its design. The useful signal at the desired rhythm is then emitted to the electromechanical device 106. Thereby, the electromechanical device 106 can control the escapement 105 in that the electromechanical device 106 moves the inhibition piece 110 at the time of the useful signal output. The gear train 104 can be clocked by the frequency-controlled control (based on the oscillation frequency of the clock generator 1 of the escapement.

Furthermore, a charge state measuring device 122 that is set up to measure a charge state of the battery is provided in the watch 100. The watch 100 further has a control unit 123, which is preferably set up to control the electronic clock generator arrangement 10.

When the tension of the drive spring (drive device 101) is exhausted, the electromechanical device 106 can be set up to move in such a way that the electromechanical device 106, in particular the magnetic core 107, drives the gear train 104. This can ensure that the watch 100 continues to run even when the drive spring can no longer supply the required mechanical energy. This can for example be the case when the watch 100 is not used for some time, e.g. during the night, as a result of which the drive spring cannot be tensioned by the automatic winding device 121. For this purpose, a device for decoupling the drive spring from the escapement 109 and the gear train 104 can preferably be provided in the watch 100.

When the charge state of the rechargeable battery measured by the charge state measuring device 122 is less than a predetermined charge state value, the control device 122 is set up to interrupt the power supply of the electromechanical device 106. Thus, a complete discharge of the rechargeable battery can be avoided. In other words, the power supply of the electromechanical device 106 is interrupted from a certain minimum energy level in the rechargeable battery until the drive spring is again tensioned by the movement of the watch 100. Otherwise, the rechargeable battery would be completely discharged and thus would not be able to operate the electromechanical device 106 immediately, when the watch 100 is put back into operation, and would accordingly not be able to start up the oscillation process of the piezoelectric oscillation crystal.

The present invention provides a watch 100 that is as accurate as a quartz watch and at the same time driven like an automatic watch. In other words, the watch 100 is a hybrid watch, in which the control of the clocking is carried out using the oscillation frequency of the piezoelectric oscillation crystal and the driving of the gear train 104 occurs by a drive spring. The watch 100 further comprises a high power reserve due to the rechargeable battery that powers the components of the watch 100 that operate with electricity and is rechargeable by the energy-harvesting device 120.

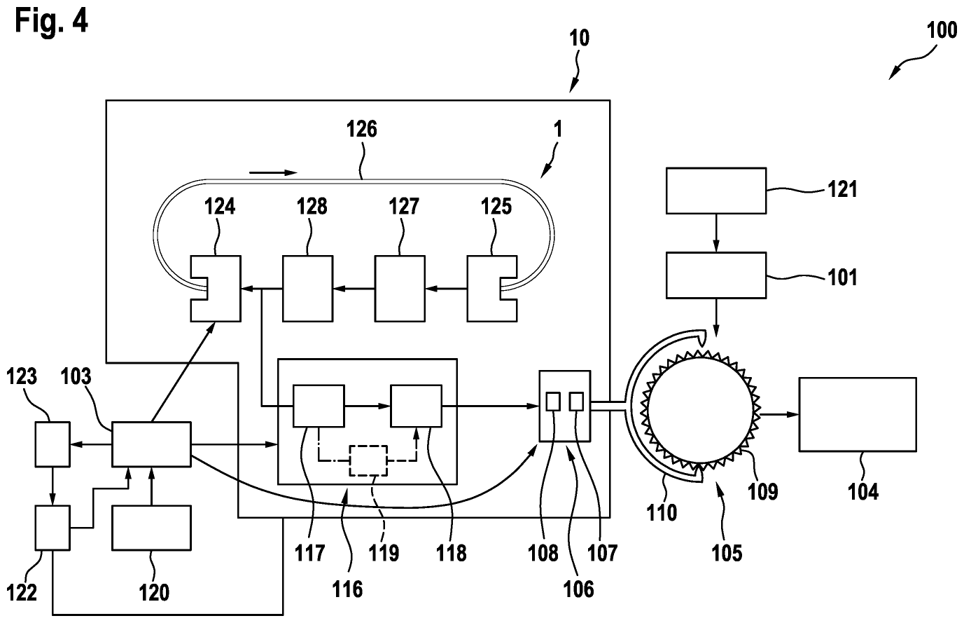

FIG. 4 refers to a watch 100 according to a second embodiment of the invention.

The watch 100 according to the second embodiment differs from the watch 100 according to the first embodiment in the design of the clock generator arrangement 10, in particular in the design of the clock generator 1.

The clock generator 1 in the watch 100 according to the second embodiment is formed as an oscillation system that comprises an optical fiber 126, a light transmitter 124 for feeding a clocked light signal into the optical fiber 126 and a light receiver 125 for receiving the light signal and for generating an electrical signal. The light transmitter 124 is connected to the light receiver 125 via the optical fiber 126.

The electronic useful signal generating device 116 is set up to generate a useful signal, using which the watch 100 can be clocked, based on a frequency of the electrical signal.

The light transmitter 124, which is formed in particular as a semiconductor laser, is in particular set up to send a light pulse (clocked light signal) through the optical fiber 126. The light receiver 125 is in this case set up to receive the light pulse and convert it into a current pulse (electrical signal).

Furthermore, the oscillation system comprises an (electrical) amplifier 127 and a signal conditioning device 128. The amplifier 127 is arranged between the light emitter 124 and the light receiver 125 and is set up to amplify the current pulse generated by the light receiver 125. The signal conditioning device 128 is arranged between the light transmitter 124 and the amplifier 127 and is set up to condition the current pulse and send it to the light transmitter 124.

It can be derived from FIG. 4 that a circuit, which corresponds to the clock generator 1 of the watch 100, is formed by the light transmitter 124, the optical fiber 126, the light receiver 125, the amplifier 127 and the signal conditioning device 128.

For generating the oscillation frequency of the clock generator 1, a light pulse is firstly sent from the light transmitter 124 through the optical fiber 126. Due to the length of the optical fiber 126, the light pulse traveling in a direction from the light transmitter 124 to the light receiver 125 requires a certain period of time to arrive at the light receiver 125. In other words, this period of time is prescribed by the predetermined length of the optical fiber 126. The light pulse is converted into a current pulse by the light receiver 125 and sent on to the amplifier 127. The amplifier amplifies the current pulse and sends it on to the signal conditioning device 128. The current pulse is conditioned there and passed on to the light transmitter 124. From there, a new light pulse is sent into the optical fiber 126.

This process is repeated a certain number of times per second. The number of repetitions per second is determined by the length of the optical fiber 126. For a length of approx. 20 m, the process is repeated 10 million times per second. Thus, an oscillation frequency of the clock generator 1 of 10 MHz is generated, which can be picked up between the signal conditioning device 128 and the light emitter 124.

For generating the useful signal, using which the watch 100 can be clocked, the signal with the oscillation frequency can be transmitted to the frequency divider 117 and/or the pulse counter 119. There, the oscillation frequency is broken down to the frequency of the desired useful signal, e.g. to 1 Hz or 8 Hz. The frequency of the useful signal is now passed on to the output device 118. There, a strong useful signal is output, which excites the electromechanical device 106, in particular the magnetic core 107, to make a movement. This movement of the magnetic core 107 moves the inhibition piece 110 of the escapement 105 and thus clocks the gear train 104 of the watch 100. The escapement wheel 109 of the escapement 105 obtains the energy for driving the gear train 104 from the drive spring (drive device 101), which in turn is wound by the winding device 121.

Thus, the gear train 104 of the watch 100 is driven by the drive spring, but is timed by the oscillation frequency of the clock generator 1 formed as an oscillation system.

Thus, the watch 100 according to the second embodiment has the precision of the light-driven oscillation system described above, but is still a watch with a mechanical movement. The current for the clock generator arrangement 10, the components of which are responsible for the generation of the oscillation frequency, the generation of the useful signal based on the oscillation frequency and the actuation of the escapement 105 using the useful signal, is supplied by the rechargeable battery, which is charged by the energy-harvesting device 120.

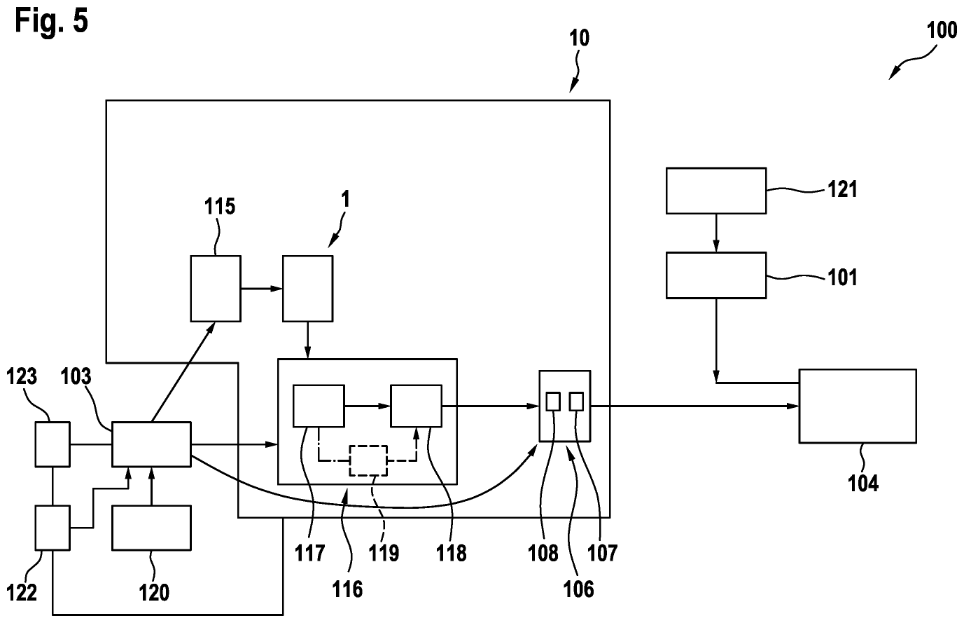

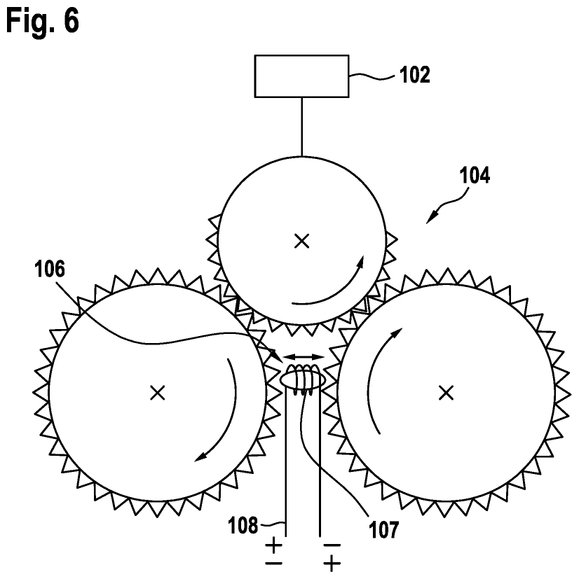

FIGS. 5 and 6 refer to a watch 100 according to a third embodiment of the invention.

The watch 100 according to the third embodiment differs from the watch 100 according to the first embodiment in that, the electromechanical device 106 in the watch 100 according to the third embodiment directly engages with the gear train 104 in a clocked manner. In other words, no escapement is provided in the watch 100 according to the third embodiment. This means that the clock generator arrangement 10 replaces the combination of a conventional balance wheel and a conventional escapement of a conventional mechanical watch.

In particular, the electromechanical device directly engages the gear train 104 in an inhibiting manner, in order to alternately bring the gear train 104 to a standstill and release it again.

In the watch 100 according to the third embodiment, the electromechanical device 106 is also formed as an actuator comprising a magnetic anchor 107 and a magnetic coil 108.

Thus, the magnetic anchor 107 engages directly in a clocked manner with the gear train 104.

However, it is also possible that the electromechanical device 106 is formed as a stepper motor, which engages directly with the gear train 104 in a clocked manner.

Except for the described special features of the watch 100 according to this embodiment, its mode of operation basically corresponds to that of the watch 100 according to the first embodiment. However, the electromechanical device 106 does not control an escapement, but rather the gear train 104 directly, which is thus clocked.

The watch 100 according to the fourth embodiment differs from the watch 100 according to the second embodiment in that the electromechanical device 106 in the watch 100 according to the fourth embodiment engages directly with the gear train 104 in a clocked manner. This means that, as in the watch 100 according to the third embodiment, the clock generator arrangement 10 here replaces the combination of a conventional balance wheel and a conventional escapement of a mechanical watch.

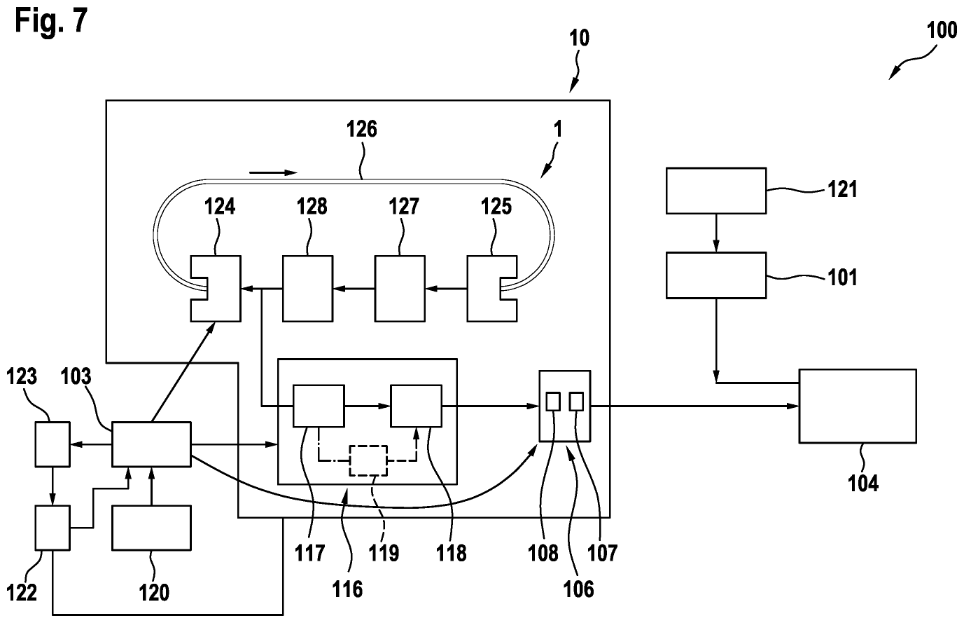

FIG. 7 refers to a watch 100 according to a fourth embodiment of the invention.

The electromechanical device 106 in the watch 100 according to the fourth embodiment is also formed as an actuator comprising a magnetic anchor 107 and a magnetic coil 108. Thus, the magnetic anchor 107 engages directly in the gear train 104 in a clocked manner.

Alternatively, the electromechanical device 106 can be formed as a stepper motor, which then engages directly with the gear train 104 in a clocked manner.

Except for the described special features of the watch 100 according to this embodiment, its mode of operation corresponds to that of the watch 100 according to the second embodiment. However, the electromechanical device 106 does not control an escapement, but instead directly controls the gear train 104, which is thus clocked.

In addition to the above written description of the invention, explicit reference is hereby made to the drawings of the invention in FIGS. 1 to 7 for a supplementary disclosure thereof.

1. A watch comprising:
a clock generator arrangement with a clock generator, an electronic useful signal generating device and an electromechanical device,
a gear train,
a drive device for driving the gear train, and
a watch display device, which is connected to the gear train,
wherein:
the clock generator has a predetermined oscillation frequency,
the electronic useful signal generating device is set up to generate a useful signal based on the oscillation frequency of the clock generator,
the electromechanical device is movable via the useful signal generated by the electronic useful signal generating device, whereby the electromechanical device engages directly or indirectly with the gear train in a clocked manner, and
the watch display device is movable by the gear train.

2. The watch of claim 1, wherein the electromechanical device indirectly engages with the gear train, whereto the watch comprises an escapement, which is in engagement with the gear train and is drivable by the electromechanical device.

3. The watch of claim 1, wherein the electromechanical device is formed as an actuator.

4. The watch of claim 3, wherein the actuator comprises a magnetic anchor and a magnetic coil that is set up to move the magnetic anchor via the useful signal.

5. The watch of claim 1, wherein the electromechanical device is formed as a stepper motor.

6. The watch of claim 1, wherein the clock generator is formed as piezoelectric oscillation crystal, preferably wherein:
the piezoelectric oscillation crystal is designed in the form of a fork oscillator, and/or
the piezoelectric oscillation crystal has a length, a width and a height each of at least 1 mm, preferably of at least 1.5 mm, and/or wherein the piezoelectric oscillation crystal is designed in the form of a cuboid.

7. The watch of claim 6, wherein the piezoelectric oscillation crystal is a quartz oscillation crystal or a tourmaline oscillation crystal.

8. The watch of claim 1, wherein the clock generator is formed as an oscillation system, which comprises an optical fiber, a light transmitter for feeding a clocked light signal into the optical fiber and a light receiver for receiving the light signal and for generating an electrical signal based on the received light signal, wherein the electronic useful signal generating device is set up to generate the useful signal based on a frequency of the electrical signal.

9. The watch of claim 1, wherein the electronic useful signal generating device has a frequency divider and/or a pulse counter.

10. The watch of claim 1, further comprising a power supply device for power supplying the electronic clock generator arrangement with electrical energy, which is formed as a rechargeable battery, and in particular also an energy-harvesting device, which is set up to charge the rechargeable battery.

11. The watch according to claim 10, further comprising a charge state measuring device, which is set up to measure a charge state of the rechargeable battery, and a control unit, which is set up to interrupt a power supply of the electromechanical device, when the charge state of the rechargeable battery is less than a predetermined charge state value.

12. The watch of claim 1, wherein the drive device comprises a drive spring and the electromechanical device is set up to move such, that, in the case of exhausted tension of the drive spring, the electromechanical device drives the gear train.

13. The watch according to claim 12, further comprising a charge state measuring device, which is set up to measure a charge state of the rechargeable battery, and a control unit, which is set up to interrupt a power supply of the electromechanical device, when the charge state of the rechargeable battery is less than a predetermined charge state value.

14. The watch of claim 1, wherein the watch comprises a winding device formed as a self-winding mechanism and/or hand-winding mechanism.

15. The watch of claim 1, wherein the clock generator has an oscillation frequency, which has a value, which comprises only the number 8 or only the number 8 and the number 0, wherein the oscillation frequency is in particular 8888 Hz, 88888 Hz, 888888 Hz, 8888888 Hz, 8 kHz, 88 KHz, 888 KHz or 8888 KHz.
